(19) United States
(12) Patent Application Publication
(10) Pub. No.: US 2017/0142891 A1
(43) Pub. Date: May 25, 2017

(54) PRODUCT AND VARIETY TRACKING AND TANK MIX INTEGRATION FOR AN AGRICULTURAL SYSTEM

(71) Applicant: CNH Industrial America LLC, New Holland, PA (US)

(72) Inventors: Natalia Lucas, Mundelein, IL (US); Bushra Ali, Bensenville, IL (US); John Stratton, Denver, CO (US)

(73) Assignee: CNH Industrial America LLC, New Holland, PA (US)

(21) Appl. No.: 14/949,446

(22) Filed: Nov. 23, 2015

(51) Int. Cl. A01B 79/00; G06F 3/0484; A01C 7/10

(52) U.S. Cl. CPC A01B 79/005; A01C 7/102; G06F 3/04847

(57) ABSTRACT

An agricultural system including a vehicle, a product delivery system, a controller and a display mounted in the vehicle, the controller is in controlling communication with the product delivery system. The controller is configured to interact with a user by way of the display. The controller being configured to display product delivery information on the display and to allow the user to modify product delivery rates, product selections and/or sources for product by way of a continuously linked selection process.

### BACKGROUND OF THE INVENTION

1. Field of the Invention

The present invention relates to a controller for an agricultural system, and, more particularly, to a display regime for agricultural product and variety tracking along with tank mix integration carried out under the control of a controller associated with the agricultural system.

2. Description of the Related Art

Modern farming practices have developed to improve the speed and efficiency of the farm equipment used to plant, maintain, and harvest crops. For example, tractors include a global positioning system (GPS) and a controller in the tractor is configured to provide a topographical view of a field and to identify the location of the tractor within the field based on the GPS coordinates. In addition, multiple agricultural implements may be connected to the tractor. During planting, for example, the tractor may pull an air cart having multiple containers including one or more types of seed and/or fertilizer. The tractor may also pull a planter to plant the seeds.

The controller on the tractor may be configured to control operation of the implements connected to the tractor. Different models of each implement may include varying operating parameters such as capacity, rate of application, or number of rows. The operating parameters may also depend, for example, on the configuration or operating characteristics of the tractor or the location within the field. Each of the operating parameters needs to be configured prior to operation of the respective implement. Consequently, each implement typically includes a configuration module stored on the controller of the tractor to configure operation of the respective implement.

However, as the number of features on the agricultural implements increase so does the number of operating parameters and the complexity of configuring operation of the tractor and the connected implements. In addition, different implements such as the air cart and planter may interact with each other. Changing the configuration of a parameter on one of the implements may impact operation of the other implement.

In a known type of planting implement, seed planting or row units are attached to a toolbar extending transverse to the direction of planting. The toolbar is coupled to a tractor or other work vehicle suitable for pulling the planting implement along a field that is to be seeded to a crop. Each planting unit includes a ground penetrating assembly, often including one or more discs, for opening a seed trench or furrow in the ground as the planting implement is pulled across a field. Components of the ground penetrating assembly shape the bottom and sides of the seed trench, and a seed-metering device provides individual seeds at a controlled rate for deposit in the seed trench. Furrow closing components of each row unit close the seed trench in a controlled manner.

Agricultural planters are commonly used implements to plant seeds in soil. An agricultural planter can include a chassis that carries one or more storage tanks carrying seed, and chemical applications that are to be applied to the field during the planting operation, a hitch mechanism that attaches to a tractor or other implement pulled by a tractor, and a tool bar that row units can be connected to so they are carried by the chassis. The planter can also include a pneumatic system carried by the chassis that supplies pressurized air to transport the seeds or other particulate from the storage tanks to the row units.

Each row unit of the agricultural planter places seeds in the field. Typically, the row units are laterally arranged along a length of the tool bar so that as the planter is pulled across the field, each row unit plants seeds at predefined intervals along the path it is pulled across. To plant seeds, the row units perform four main operations as they are pulled: opening a trench in the soil; placing a seed into the formed trench at appropriate intervals; closing the formed trench to put soil on top of the placed seed; and packing soil on top of the seed to provide desirable soil contact with the placed seed. To open a trench in the soil, a furrowing disc system, also called an opening disc, cuts into the soil and rotates, dislocating soil as it rotates to form the trench.

Once the trench is open, a seed is placed in the trench by a metering device which receives seeds from the main storage tank(s) or a row unit storage tank and typically utilizes a combination of differential air pressure, to select the seed, and gravity to place the seed in the trench at predefined intervals along the pulled path so that adjacent seeds in the row are not too close to one another. One or more closing discs carried behind the furrowing disc are pressed into the soil and also rotate as the planter is pulled to replace soil dislocated by the furrowing disc in the trench or dislocate adjacent soil into the trench to cover the seed placed in the trench with soil. Finally, at least one pressing wheel carried behind the closing disc(s) exerts pressure on the soil covering the seed to press the soil down onto the seed and provide good soil contact with the seed. By having multiple row units working in unison as the planter is pulled across a field, many seeds can be effectively planted and products (such as fertilizer and herbicides) are delivered in an efficient manner.

A control system to monitor the functioning of the planter is known. The control systems allow for entry of information relative to the planter with the information entry taking place in separate areas.

What is needed in the art is a robust display that presents product, variety and tank mix information and selections in an intuitive and efficient manner.

### SUMMARY OF THE INVENTION

The present invention provides a progressive integrated entry and selection of product information to control and monitor operation of a product delivery system, the entry and selection sections being in a continuously linked selection process.

The invention in one form is directed to an agricultural system including a vehicle, a product delivery system, a controller and a display mounted in the vehicle, the controller is in controlling communication with the product delivery system. The controller is configured to interact with a user by way of the display. The controller being configured to display product delivery information on the display and to allow the user to modify product delivery rates, product selections and/or sources for product by way of a continuously linked selection process.

The invention in yet another form is directed to a method of displaying information for an agricultural system that includes a vehicle, a product delivery system coupled to the vehicle, a controller and a display mounted in the vehicle. The controller is coupled to the display and the product delivery system. The method includes the steps of displaying product delivery information on the display; and allowing the user to modify product delivery rates, product selections and/or sources for product by way of a continuously linked selection process.

An advantage of the present invention is that user can create, manage and track products delivered by the agricultural system, such as a planter, are all available in one consecutively continuous linked selection process on the display screen.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic representation of a complete agricultural system using an embodiment of a display/entry regime of the present invention;

FIG. 2 is a depiction of an implement of FIG. 1 that is subject to the selections made on the display/entry regime of the present invention;

FIG. 3 is a depiction of a product assignment screen for the liquid controller of the display/entry regime of the present invention;

FIG. 4 is a depiction of a product assignment to drive 1 of the liquid controller;

FIG. 5 illustrates the editing of a product application rate data;

FIG. 6 illustrates the addition of a product to the products library; and

FIG. 7 is an illustration of a display bar having a visual representation of the contents of the tanks of the four drives and the amount of time remaining until the tank needs to be refilled at the current application rate.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

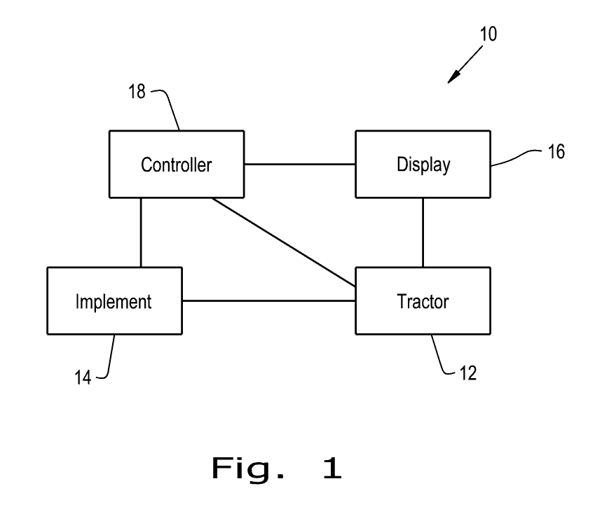

Referring now to the drawings, and more particularly to FIG. 1, there is shown an embodiment of an agricultural system 10 having a tractor 12, an implement 14 and a display 16 that is incorporated in tractor 12. Display 16 is an interactive display 16 configured to provide information to a user and allow the user to direct the operation of tractor 12 and/or implement 14. A controller 18 receives information from sensors on implement 14 and tractor 12, processes, stores and displays selected portions of that information and other stored information such as setup information and configuration selections. The displaying of information and control features on display 16 takes into account needed setup and configuration aspects of the agricultural system 10.

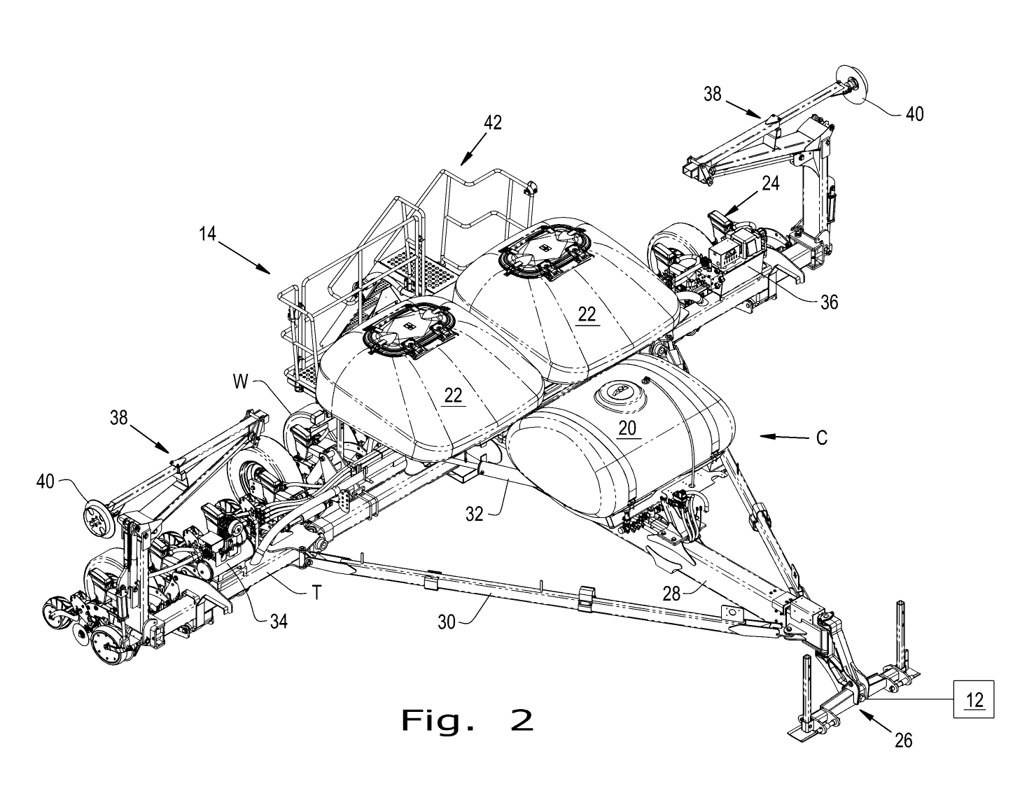

Now, additionally referring to FIG. 2, there is shown some details of a typical implement 14 in the form an agricultural planter 14 which generally includes a chassis C forming a support structure for components of the planter 14 that can be formed by a hitch assembly at a front of the planter 14 connected to a tool bar T, main wheels W carried by the chassis near a rear of the planter 14, one or more storage tanks 20 and 22 that can be filled with seed or other agriculture material carried by the chassis, and a plurality of row units 24 connected to the tool bar T and arranged laterally across a length of the tool bar T so that they are carried by the chassis. The chassis C can include a hitch 26 configured to be connected to a tractor 12 or other agricultural implement (not shown) so that the planter 14 can be pulled in a forward direction of travel. The hitch 26 can be integrally formed with or connected to a hitch bar 28 that is connected to the tool bar T by bracing bars 30 and one or more cylinders 32. As can be seen, the planter 14 can also have various hydraulic, pneumatic, and electrical lines (unnumbered) throughout to support various cylinders and systems that are included on the planter 14, such as a pneumatic system 34 connected to the tool bar T and an electric generator 36 also connected to the tool bar T. A marking device 38 can be connected to each lateral end of the tool bar T and extendable so that a marking disc 40 of the marking device 38 can create a line in the soil as the planter 14 is pulled that helps a user in positioning the planter 14 to create subsequent rows. A stair assembly 42 can be mounted to the back of the planter 14 to allow for an operator to access the storage tanks 22.

While a planter 14 is shown in detail it is to be understood that any agricultural implement 14 can be utilized. Further, although a towing of implement 14 by tractor 12 is illustrated herein it should be understood that tractor 12 may be any agricultural, construction, or forestry vehicle that can be coupled to various implements 14.

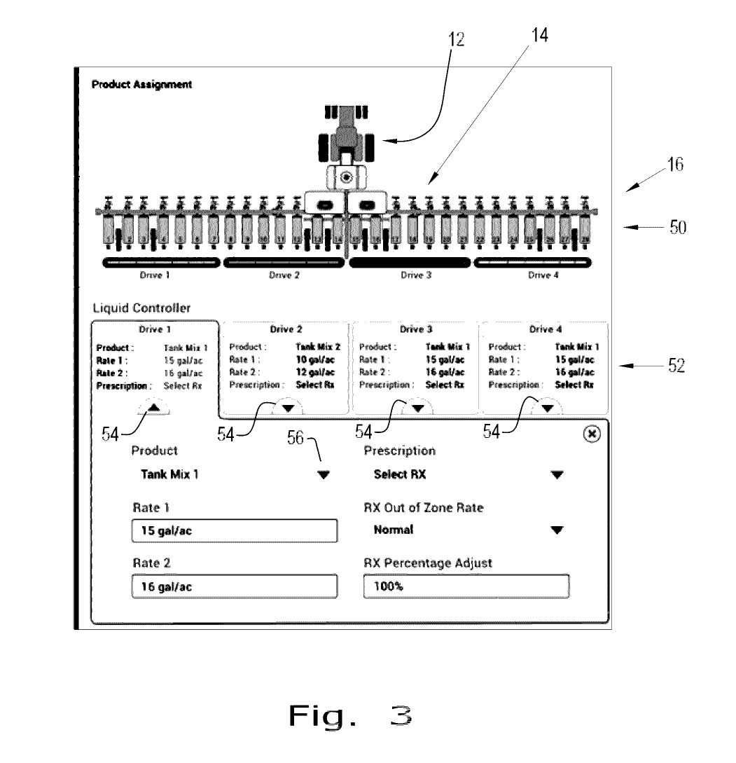

Now, additionally referring to FIG. 3, there is illustrated information/selection screens that are provided by the present invention with an image of tractor 12 coupled to an image of implement 14 illustrated in a top portion of display 16. Implement 14 is in the form of a multi-row planter 14 shown here with 4 drive units that each service a select group of row units 24. Implement 14 can be thought of as a product delivery system 50, which may be integral with tractor or vehicle 12. The delivery of product is monitored on display 16 in the form of product delivery information 52. The liquid controller section allows a product selection process to be carried out, representative of a product being delivered with that particular set of row units, or relative to an applicator that is associated with the selected row units, to be applied to the field. Here Drive 1 has “Tank Mix 1” selected and two application rates along with prescription options are illustrated in the associated pull down box.

As can be seen in the product delivery information 52 sections for Drive 2, Drive 3 and Drive 4 the product selection, the two application rates and the prescription selections are shown. For Drive 2 the product selection is Tank Mix 2 and the application rates are 10 gal/acre and 12 gal/acre, with the prescription selection being Select Rx. For Drive 3 the product selection is Tank Mix 1 and the application rates are 15 gal/acre and 16 gal/acre, with the prescription selection being Select Rx. For Drive 4 the product selection is Tank Mix 1 and the application rates are 15 gal/acre and 16 gal/acre, with the prescription selection being Select Rx.

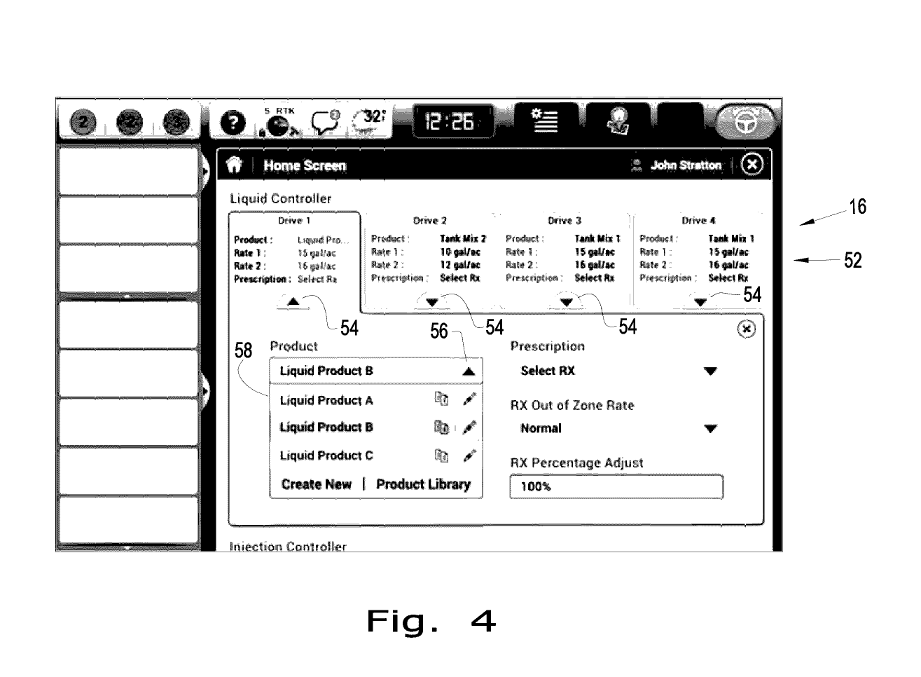

By touching or selecting the down arrow on the Product box selections, like those shown in FIG. 4, are displayed allowing a particular product that has selected properties to be selected. Display 16 of FIG. 4 is shaped different than display 16 of FIG. 3 to illustrate the differing display formats with which the present invention works.

An arrow selector 54 in each of the product delivery information 52 boxes allows for the modification of the selections of product type, product sources, product formulations and delivery rates to be undertaken. The selection is part of a continuously linked selection process, where in FIG. 3 the process is started by selecting an arrow 54, which in Drive 1 is now represented with an up arrow with the highlighted and continuous border noting that the changes therein are associated with Drive 1.

Now, additionally referring to FIG. 4, with the selection of arrow selector 56 (in FIG. 3) having been toggled. A product selection section 58 opens up allowing an already defined product to be selected. Additionally, as can be seen at the bottom of product selection section 58 a new product selection can be commenced or the product library can be accessed. Also, a product can be edited by the appropriate selection within a product box.

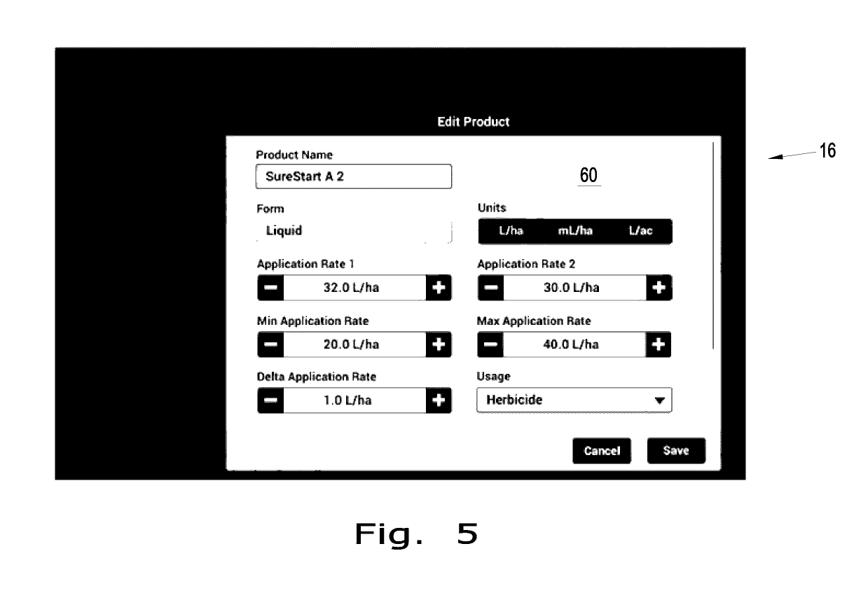

Now, additionally referring to FIG. 5 there is shown an Edit Product screen 60 where the product selection can be named in the Product Name box. The type or form of the product is selected in the Form box, with “Liquid” being selected. The preferred type of units is selected in the Units box and the Application Rates can be selected with rate boundary, minimum and Maximum rates being selected using the +/− selectors.

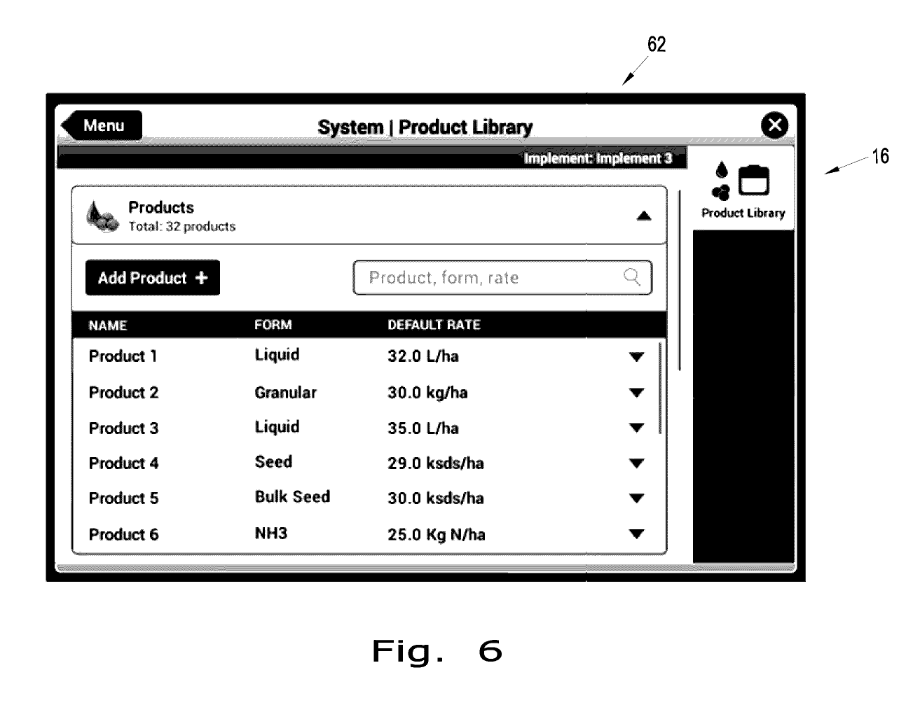

Now, additionally referring to FIG. 6 there is shown a product library screen 62, which is displayed if the Product Library selection is made in product selection section 58. A product can be selected or added or edited from this screen. When a product is selected it is then input into the next lower selection from which the continuously linked selection process came from. Here for example if Product 5 is selected we know that we are dealing with a seed tank and that the product application rate will be 30,000 seeds/ha. The product selections can be limited to possible selections appropriate to the lower selection area. For example if the product library is accessed by way of the Liquid Controller section then the Bulk Seed of Product 5 cannot be selected as the product delivery since the bulk seeds are not a liquid. However, access to the product library will allow editing of the products therein.

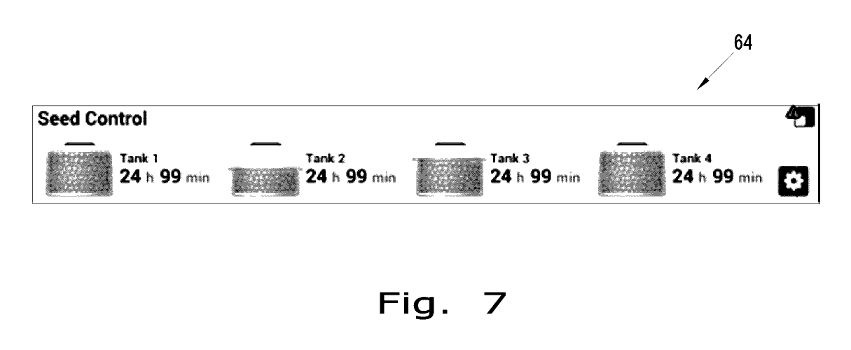

Now, additionally referring to FIG. 7, there is shown a product delivery display 64, where a graphical illustration of tanks with the relative contents being displayed and a computed time as to when the tanks will require refilling. The contents of the actual tanks is computed relative to the amount of product added or transferred to the tank, with the computed application rate that draws from the tanks being subtracted to provide a virtual tank contents amount. Product delivery screen 64 may be displayed with or instead of other product delivery information.

The present invention is an integrated user interface that allows product types to be created, tracked and managed. The product types are application products, seed varieties, tank mixes, and the amount of product remaining in those tanks as part of an implement application control system. The products and varieties are used to log what the farmer was applying in the field during implement operations. The products and varieties get “assigned” to drives on the physical implement 14, and then based on each drive's performance, the system 50 calculates how much of that product was used.

Advantageously, the present invention makes the product assignment of products, rates and varieties to drives happen all in one place on the display. The graphics show relationships to the whole system 10. The used can create product and assign it within a single process, and may use picklists that have create and manage options as well. The present invention groups the product creation, product assignment and tank mix setup into a single area. When changing the product assignment, the system also prompts the user to enter a new volume for how much has been put into the tank associated with the selection.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures 52429 from the present disclosure as come within known or customary practice in the art to which this invention pertains and which fall within the limits of the appended claims.

What is claimed is:

1. An agricultural system, comprising:
a vehicle;
a product delivery system coupled to said vehicle;
a controller in controlling communication with said product delivery system; and
a display mounted in said vehicle, said display being coupled to said controller, said controller being configured to interact with a user by way of said display, said controller being configured to display product delivery information on said display and to allow the user to modify at least one of product delivery rates, product selections and sources for product by way of a continuously linked selection process.

2. The agricultural system of claim 1, wherein said continuously linked selection process is entered from an operational display that illustrates the operation of said product delivery system, said operational display containing identifying information relative to defined portions of said product delivery system.

3. The agricultural system of claim 2, wherein said product delivery system includes a plurality of delivery ports, said product delivery system providing for simultaneous delivery of products at differing rates to selected ones of said delivery ports.

4. The agricultural system of claim 3, wherein said sources for product include a first source and a second source, said continuously linked selection process being configured to allow the user to select either said first source or said second source to deliver the product to selected delivery ports.

5. The agricultural system of claim 2, wherein said operational display is configured to display at least some product delivery information for each defined portion of said product delivery system.

6. The agricultural system of claim 5, wherein said delivery information includes at least one of a product name, a first product delivery rate and a prescription.

7. The agricultural system of claim 6, wherein said delivery information further includes a second product delivery rate.

8. The agricultural system of claim 7, wherein said product delivery system includes a plurality of row units each being configured to deliver the product to a layer of soil.

9. The agricultural system of claim 8, wherein said plurality of row units are grouped into at least two groups, each of said groups having product delivery information shown on said operational display.

10. The agricultural system of claim 1, wherein said product delivery system includes a plurality of containers holding product, a calculation of product remaining in each of said containers being undertaken by said controller resulting in information, said information being provided on said display.

11. The agricultural system of claim 1, wherein said continuously linked selection process is configured to allow a product to be selected for delivery to a selected portion of said product delivery system, said continuously linked selection process being further configured to allow a rate of delivery of the product to be selected, said continuously linked selection process being further configured to allow a product and a rate to be selected from a product library, said continuously linked selection process being further configured to return to an operational display.

12. A method of displaying information for an agricultural system that includes a vehicle, a product delivery system coupled to said vehicle, a controller and a display mounted in the vehicle, the controller being coupled to the display and the product delivery system, the method comprising the steps of:
displaying product delivery information on said display; and
allowing the user to modify at least one of product delivery rates, product selections and sources for product by way of a continuously linked selection process.

13. The method of claim 12, wherein said continuously linked selection process is entered from an operational display that illustrates the operation of said product delivery system, said operational display containing identifying information relative to defined portions of said product delivery system.

14. The method of claim 13, further comprising the steps of:
providing simultaneous delivery of products at differing rates to selected ones of said delivery ports, said sources for product include a first source and a second source; and
selecting either said first source or said second source to deliver the product to selected delivery ports.

15. The method of claim 13, further comprising the step of displaying at least some product delivery information for each defined portion of said product delivery system on said display.

16. The method of claim 15, wherein said delivery information includes at least one of a product name, a first product delivery rate and a prescription.

17. The method of claim 16, wherein said delivery information further includes a second product delivery rate.

18. The method of claim 17, wherein said product delivery system includes a plurality of row units each being configured to deliver the product to a layer of soil.

19. The method of claim 12, further comprising the step of calculating a product remaining value in each of a plurality of containers containing product; and
displaying said product remaining values on said display.

20. The method of claim 12, wherein said continuously linked selection process includes the steps of:
selecting a product for delivery to a selected portion of said product delivery system;
selecting a rate of delivery of the product;
alternatively selecting a product and a rate from a product library; and
returning to an operational display.
